(19) United States
(12) Patent Application Publication
(10) Pub. No.: US 2008/0013526 A1
(43) Pub. Date: Jan. 17, 2008

(54) Main apparatus of communication system, and emergency notice sending method

(75) Inventor: Hideaki Nakai, Hino-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/729,874

(22) Filed: Mar. 30, 2007

(30) Foreign Application Priority Data
Mar. 30, 2006 (JP) 2006-095783

(51) Int. Cl. H04M 11/04

(52) U.S. Cl. 370/352; 455/404.1

(57) ABSTRACT

According to one embodiment, a main apparatus includes a first memory which stores a first management table in which an emergency ID specifying a first phone terminal to be an emergency notice destination among the plurality of phone terminals on the packet communication network and positional information indicating a connection position of the first phone terminal onto the packet communication network are associated with each other, a second memory which stores a second management table in which a terminal of a second phone terminal differing from the first phone terminal and positional information indicating a connection position of the second phone terminal onto the packet communication network are associated with each other, and a controller which refers to the first and the second management tables to execute a communication connection between the first and the second phone terminals based on the reference result.

### CROSS-REFERENCE TO RELATED APPLICATIONS

This application is based upon and claims the benefit of priority from the Japanese Patent Application No. 2006-095783, filed Mar. 30, 2006, the entire contents of which are incorporated herein by reference.

### BACKGROUND

1. Field

One embodiment of the present invention relates to a main apparatus of a communication system, such as an IP telephone system, which makes voice communication among phone terminals via an Internet protocol (IP) network, and an emergency notice sending method.

2. Description of the Related Art

In recent years, a network telephone system (IP telephone system) which interactively transmits/receives images and voices as packet data in real time via a packet network has begun to be widely used. The IP telephone system may make voice communication among IP phone terminals connected to the packet network, and also may perform voice communication over countries and regions via a packet communication network as well as may implement voice communication among the IP phone terminals and phone terminals connected to a public network.

However, the aforementioned IP telephone system cannot send emergency notice to an appropriate institute because it is hard to specify the position of a sending source on the IP network.

Conventionally, a method, for connecting a mobile IP phone terminal to an emergency notice destination through an appropriate route by extracting connection positional information on a local area network (LAN) from a positional information table of a wireless LAN device to be an access point to transmit the positional information to the Internet network, has been proposed (for instance, Jpn. Pat. Appln. KOKAI Publication No. 2005-27247).

Meanwhile, according to the method given above, in general, a wireless LAN device that is located the closest to the IP phone terminal is selected. Therefore, for example, when a mobile IP phone terminal is moved at a high speed, the frequency to exchange the wireless LAN devices placed at a connecting destination is increased. Thereby, it becomes hard to specify the positional information of the mobile IP phone terminal on the LAN, and also the processing load on the mobile IP phone terminal becomes extremely heavy.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic configuration view depicting an IP telephone system regarding a first embodiment of the present invention;

FIG. 2 is an exemplary block diagram depicting a functional configuration of a main apparatus depicted in FIG. 1;

FIG. 3 is an exemplary view depicting an example of storage contents of a positional information database depicted in FIG. 2;

FIG. 4 is an exemplary view depicting an example of storage contents of a terminal information database depicted in FIG. 2;

FIG. 5 is an exemplary sequence view depicting transmitting/receiving operations of information among main apparatus and an IP phone terminal in transmitting positional information of all emergency notice destinations to the IP phone terminal connected to an IP network and activated;

FIG. 6 is an exemplary sequence view depicting transmitting/receiving operations of information between the IP phone terminal and the main apparatus in updating positional information in the first embodiment;

FIG. 7 is an exemplary flowchart depicting a control procedure of the main apparatus in conducting sending control of emergency notice in the first embodiment;

FIG. 8 is an exemplary schematic configuration view depicting an IP phone system regarding a second embodiment of the present invention;

FIG. 9 is an exemplary block diagram depicting a functional configuration of a main apparatus depicted in FIG. 8;

FIG. 10 is an exemplary view depicting an example of storage contents in an emergency sending-route database depicted in FIG. 9; and

FIG. 11 is an exemplary sequence view depicting transmitting/receiving operations of information between the main apparatus and the IP phone terminal in conducting sending control of emergency notice in the second embodiment.

### DETAILED DESCRIPTION

Various embodiments according to the invention will be described hereinafter with reference to the accompanying drawings. In general, according to one embodiment of the invention, a main apparatus of a communication system executing communication connections among a plurality of phone terminals connected to a packet communication network transferring communication packets, the plurality of phone terminals are assigned terminal IDs, comprising: a first memory which stores a first management table in which an emergency ID specifying a first phone terminal to be an emergency notice destination among the plurality of phone terminals on the packet communication network and positional information indicating a connection position of the first phone terminal onto the packet communication network are associated with each other; a second memory which stores a second management table in which a terminal of a second phone terminal differing from the first phone terminal and positional information indicating a connection position of the second phone terminal onto the packet communication network are associated with each other; and a controller which refers to the first and the second management tables to execute a communication connection between the first and the second phone terminals based on the reference result when an emergency sending request including the terminal ID of the second phone terminal is transmitted from the second phone terminal via the packet communication network.

### First Embodiment

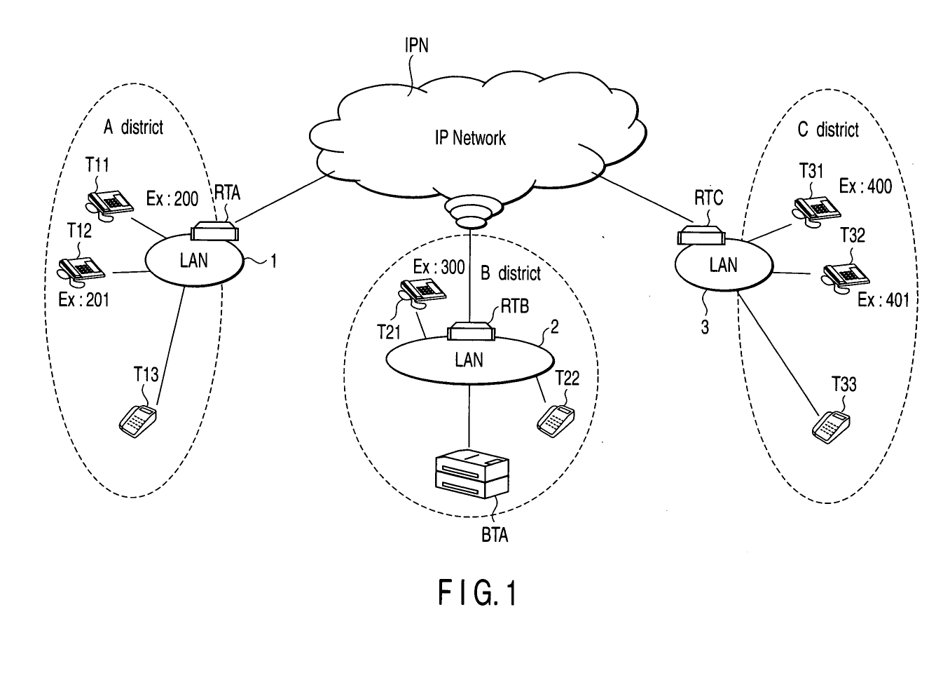

FIG. 1 is a schematic configuration view illustrating an IP telephone system regarding a first embodiment of the invention.

The system includes an IP network IPN for packet communication. The IP network IPN is laid down up to an A district, a B district, and a C district. In the A district, IP phone terminals T11, T12 and T13 are connected via a router RTA and a LAN 1, in the B district, IP phone terminals T21, and T22 are connected via a router RTB and a LAN 2, and in the C district, IP phone terminals T31, T32 and T33 are connected to a router RTC and a LAN 3. These IP phone terminals T11, T12, T13, T21, T22, T31, T32, and T33 respectively have communication processing functions and media information processing functions.

Further, these IP phone terminals T11, T12, T13, T21, T22, T31, T32, and T33 are connected to a main apparatus BTA via the IP network IPN. It is presumed that the main apparatus BTA is installed in the B district.

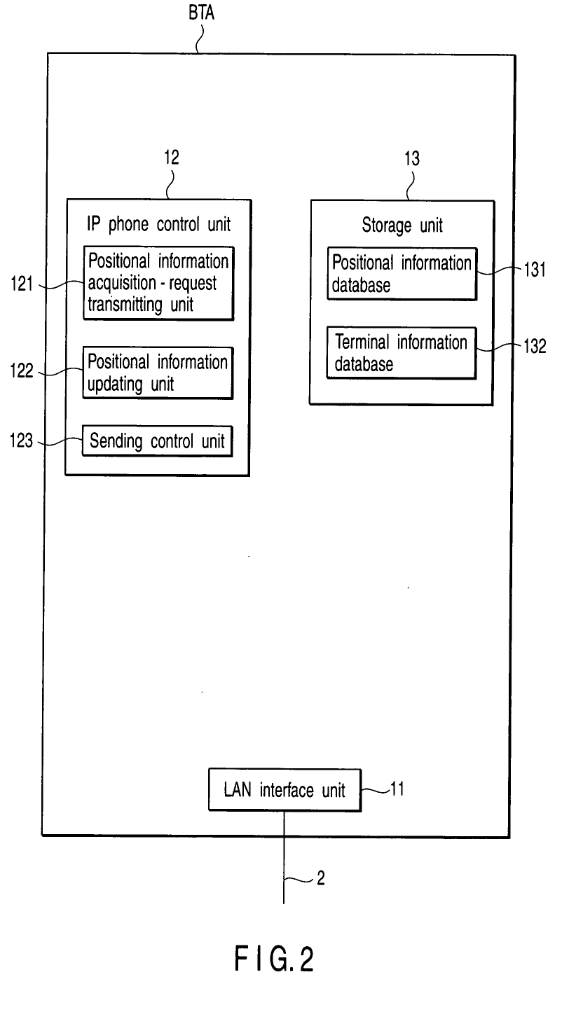

FIG. 2 is a block diagram illustrating the functional configuration of the main apparatus BTA.

The main apparatus BTA includes a LAN interface unit 11, an IP phone control unit 12, and a storage unit 13. The LAN interface unit 11 among these components conducts interface processing to and from the LAN 2.

In the storage unit 13, routing information, etc., necessary for connection control of the IP telephone control unit 12 is stored. Further, the storage unit 13 is provided with a positional information database 131 (hereinafter, referred to as database 131), and a terminal information database 132 (hereinafter, referred to data base 132).

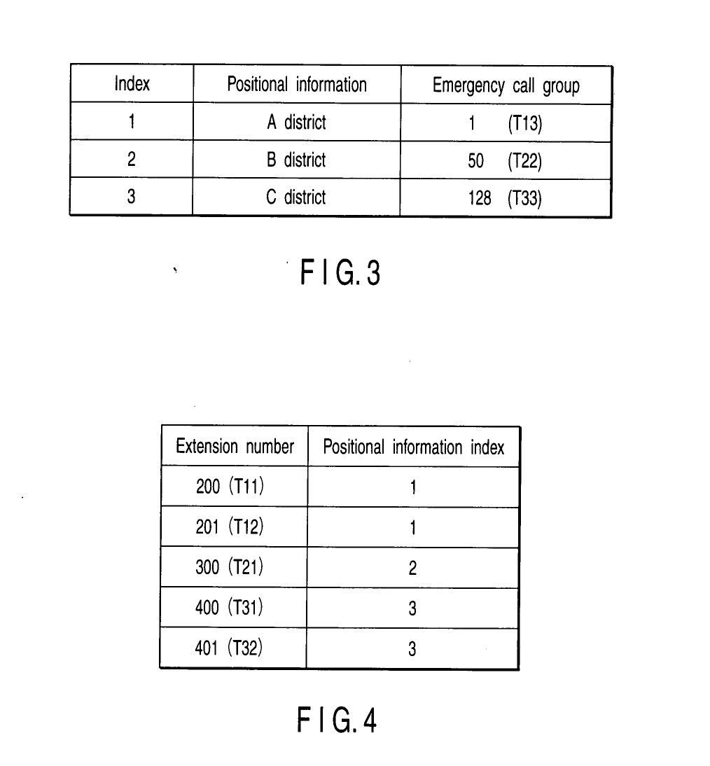

As shown in FIG. 3, data, indicating correspondence relations among positional information indexes, positional information indicating the A district, B district, and C district, and emergency call groups indicating phone numbers of the IP phone terminals T13, T22, and T33 as emergency notice destinations, is stored in the data base 13.

In the data base 132, as shown in FIG. 4, data, showing correspondence relations among the extension numbers as each terminal ID of the IP phone terminals T11, T12, T21, T31, and T32 and the position indexes indicating the A to C districts is stored.

On the other hand, the IP phone control unit 12 includes a positional information acquisition-request transmitting unit 121 (hereinafter, referred to transmitting unit 121), a positional information updating unit 122 (hereinafter, updating unit 122), and a sending control unit 123 as new functions related to the present invention in addition to the exchange connection functions of the respective phone terminals T11, T12, T13, T21, T22, T31, T32, and T33.

The transmitting unit 121 reads out whole data from the database 131 in response to network connection notice sent at the time when the IP phone terminals T11, T12, T21, T31, and T32 are activated, and transmits acquisition requests of positional information including the whole data to the phone terminals T11, T12, T21, T31, and T32 via the IP network IPN.

The updating unit 122 receives the positional information transmitted from the IP phone terminals T11, T12, T21, T31, and T32 in response to the acquisition requests to update the corresponding position indexes in the database 132.

When emergency sending requests are sent from the IP phone terminals T11, T12, T21, T31, and T32 via the IP network IPN, the sending control unit 123 refers to the database 131 and database 132, and executes sending processing to the IP phone terminals T13, T22, and T33 that are the emergency notice destinations, based on the reference results. The emergency sending requests include extension numbers of the IP phone terminals T13, T12, T21, T31 and T32 and dial key numbers specifying emergency sending.

Next, operations of the IP phone system in the configuration given above will be set forth.

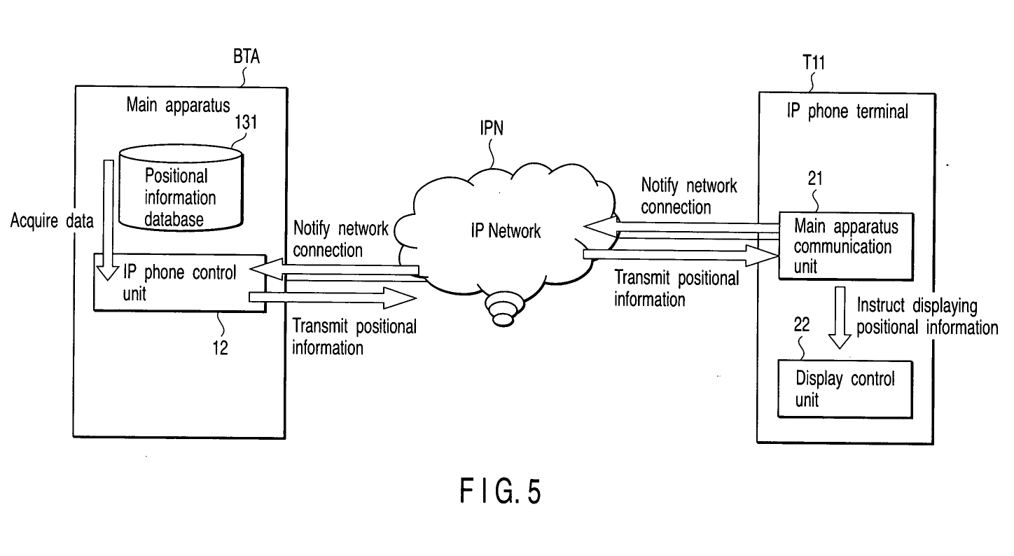

FIG. 5 is a sequence view illustrating transmitting/receiving operations of the information between the main apparatus BTA and the IP phone terminal T11 when the telephone system transmits the positional information of a whole of emergency notice destinations to the IP phone terminal 11 connected to the IP network IPN and activated.

When the IP phone terminal T11 accommodated in the main apparatus BTA is connected to the IP network IPN and started, the IP phone terminal T11 transmits network connection notice to the main BTA from a main apparatus communication unit 21.

In the main apparatus BTA, when the IP phone terminal T11 receives the network connection notice from the IP phone terminal T11, the IP phone terminal T11 acquires data from the database 131 with the positional information of the whole bases at which the IP phone terminal 11 may be placed registered therein, and notifies the data to the IP phone terminal T11.

At the IP phone terminal 11, the IP phone terminal T21 receives the positional information of the whole bases notified from the main apparatus BTA, and instructs displaying the acquired information to a display control unit 22.

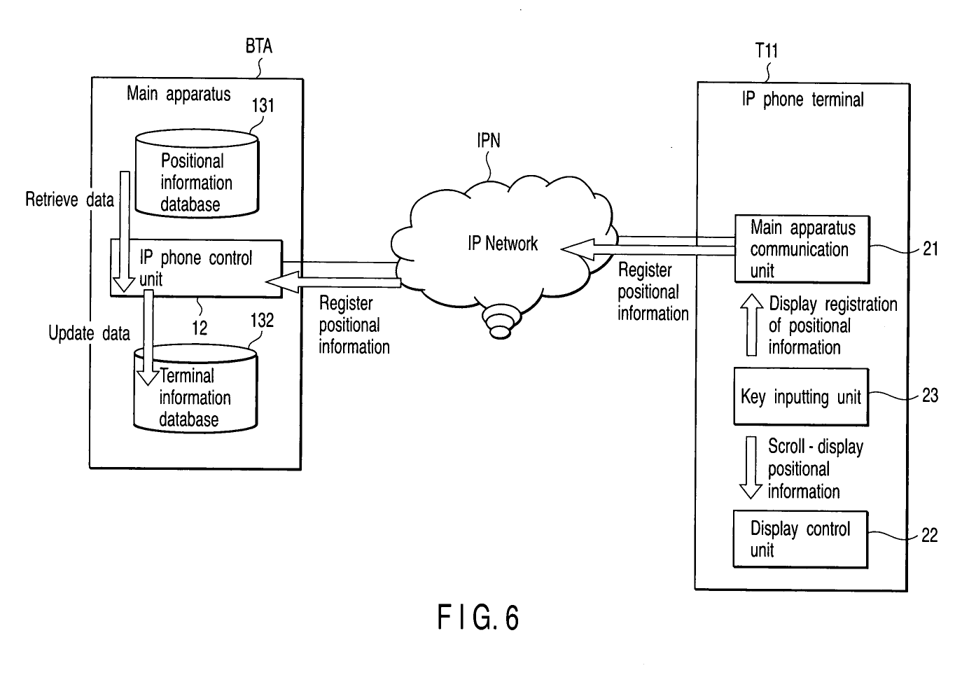

FIG. 6 is a sequence view illustrating the transmitting/receiving operations between the IP phone terminal T11 and the main apparatus BTA in updating the positional information.

After acquiring the positional information of each base from the main apparatus BTA, the IP phone terminal 11 transmits an scroll-display instruction of the positional information of the next position index in order to update position indexes by means of a key inputting unit 23 in accordance with depressing of a scroll key and to scroll-display the positional information that is currently displayed on a display unit (not shown) to the display control unit 22.

The display control unit 22 receives the scroll display instruction then clears the positional information, being currently displayed, to display the positional information of the newly notified next index.

In this situation, it is presumed that a user depresses a registration key so as to register positional information. The IP phone terminal 11 then transmits the fact that the key inputting unit 23 has completed positional information registration to the display control unit 22 by means of the key inputting unit 23 to perform a registration completion display onto the display unit. Further, the IP phone terminal T11 also transmits a positional information registration instruction to the main apparatus which transmits a positional information registration request with registration position index number added thereto to the main BTA.

The main apparatus BTA receives the positional information registration request from the IP phone terminal T11, and acquires an emergency call group number based on the registration position index number to update the registration information in the database 132.

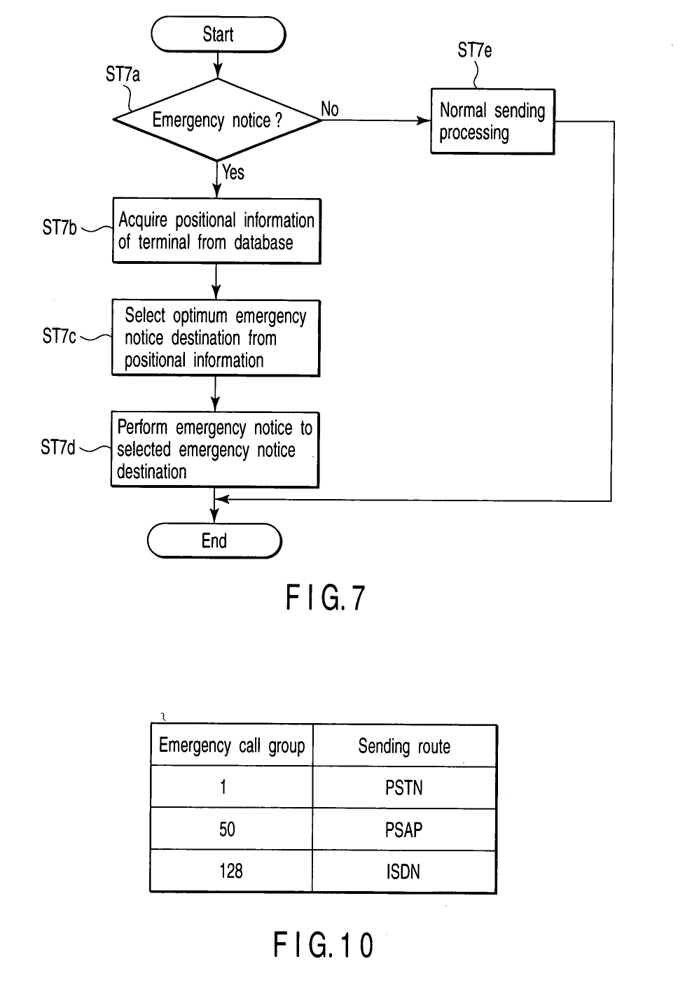

FIG. 7 is a flowchart illustrating the control procedure of the main apparatus BTA in controlling the sending of the emergency notice.

It is supposed that the user conducts a dial operation to send emergency notice from the IP phone terminal 11. The phone terminal T11 then sends its sending request to the main apparatus BTA via the LAN 1, router RTA, IP network IPN, router RTB, and a LAN 2.

On receiving the sending request, the main apparatus BTA analyzes the dial number of the termination destination included in the sending request to determine whether or not the sending request is for emergency notice (block ST7a). Here, the sending request being for the emergency notice, the main apparatus BTA reads out a positional information index “1” corresponding to the extension number of the IP phone terminal T11 included in the sending request, and further, it acquires each positional information index of the IP phone terminals T13, T22, and T33 of each emergency notice destination from the database 131 (block ST7b).

If each of the positional information indexes of the IP phone terminals T13, T22, and T33 of each emergency notice destination can be acquired from the database 131, the main apparatus BTA shifts from the block ST7b to a block ST7c to compare the positional information indexes here, then, the main apparatus BTA selects an appropriate emergency notice destination. Here, the IP phone terminal T11 belonging to the A district, and the IP phone terminal T13 of an emergency institute belonging to the same A district being selected, and the IP phone terminal T13 at an emergency institute belonging to the same A district being selected, the main apparatus BTA transmits a sending request including the emergency call group number of the IP phone terminal 13 to the IP network IPN and makes the network IPN send the sending request to the IP phone terminal 13.

Thus, a communication link is finally formed between the IP phone terminal T13 and the IP phone terminal T11 in the appropriate institutes, and a speech may be made.

In the block ST7a, if the sending request is not for the emergency notice, the main apparatus BTA shifts from the block ST7a to a block ST7e to conduct normal sending processing there.

As described above, in the first embodiment, the main apparatus BTA comprises the database 131 in which the emergency call group numbers of the IP phone terminals T13, T22, and T23 to be the emergency notice destinations and the positional information of the IP phone terminals T13, T22, and T33 are associated with one another; and the data base 132 in which the extension numbers of the IP phone terminals T11, T12, T21, T31, and T32 and each positional information index are associated with one another. For instance, when the sending request for the emergency notice is issued from the IP phone terminal T11, the main apparatus BTA reads out the positional information index of the sending source from the data base 132 based on the extension number of the IP phone terminal T11, compares the positional information index to the positional information index in the data base 131, and selects the IP phone terminal T13 belonging to the A district from the comparison result to send the emergency notice to the IP phone terminal T13.

Therefore, using the information accumulated and stored in the data bases 131 and 132 enables efficient sending of the emergency notice to an appropriate institute from the IP phone terminal T11 on the IP network IPN with a simple procedure.

In the first embodiment, for instance, when the IP phone terminal T11 is connected to the IP network IPN and started, the main apparatus BTA transmits the acquisition request for the positional information including the whole data in the data abase 131 to the IP phone terminal T11 to display the positional information onto the display unit of the IP phone terminal 11. When the user of the IP phone terminal T11 conducts the instruction input operation for position registration of the IP phone terminal T11 based on the displayed positional information of the whole of the emergency notice destinations, the IP phone terminal T11 transmits the positional information index thereof to the main apparatus BTA, and updates the positional information index of the corresponding IP phone terminal T11 in the database 132.

Accordingly, at every connection of the IP phone terminals to the IP network IPN, the main apparatus BTA may acquire the connection positional information and automatically update the database 132. The user of the IP phone terminal T11 needs not separately prepare an information magazine, etc., and also can register the positional information of the IP phone terminal T11 in the main apparatus BTA with ease and accuracy by conducting an instruction input in a state in which the positional information of the whole of the emergency notice destinations is displayed.

### Second Embodiment

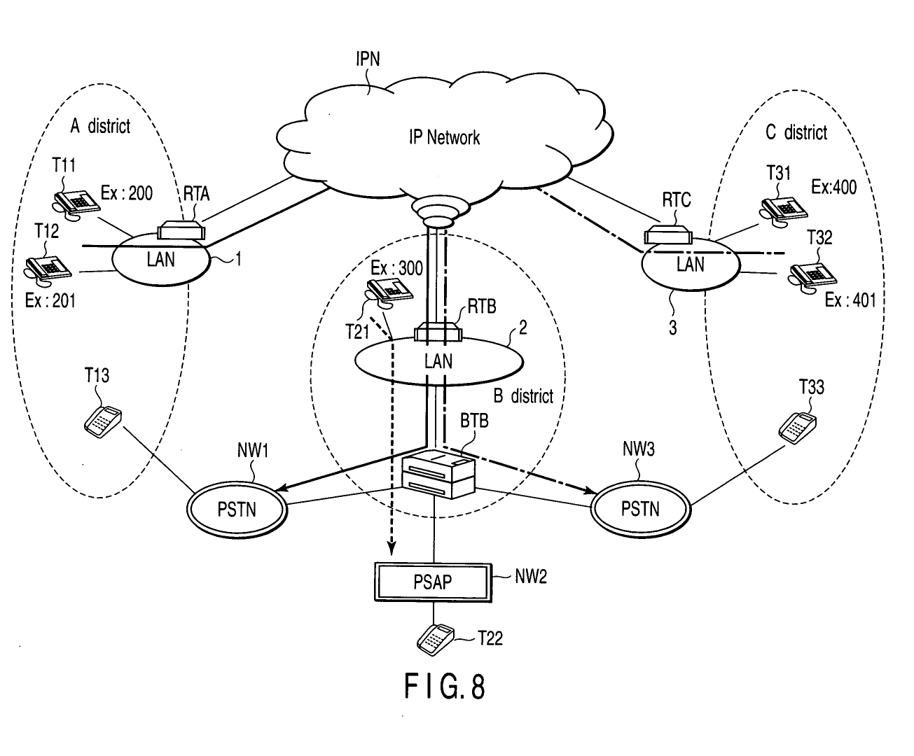

FIG. 8 is a schematic configuration view illustrating an IP phone system regarding a second embodiment of the present invention. In FIG. 8, the same components as those of FIG. 1 are designated by the identical symbols and their detailed descriptions will be eliminated.

In this system, the main apparatus BTB connects the IP phone terminals T13, T22, and T33 disposed in emergency institutes via a public switched telephone network (PSTN) NW1, a public safety answering point (PSAP) NW2, and an integrated service digital network (ISDN) NW3.

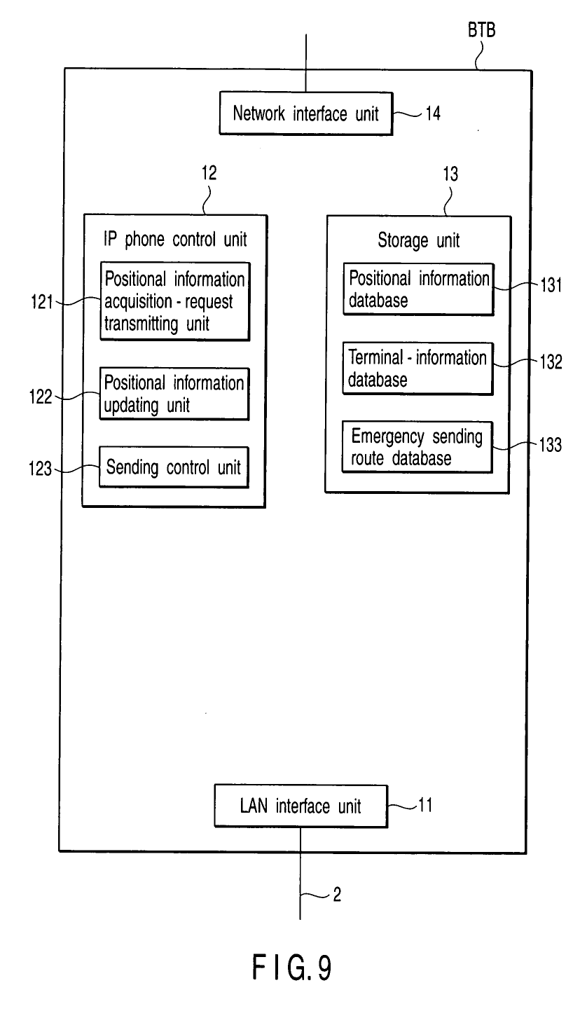

FIG. 9 is a block diagram illustrating the functional configuration of the main apparatus BTB. In FIG. 9, the same components as those of FIG. 2 are designated the identical symbols and their detailed descriptions will be omitted.

The main apparatus BTB includes a network interface unit 14. The network interface unit 14 conducts interface processing to and from the PSTN NW 1, PSAP NW2 and ISDN NW3.

The storage unit 13 is provided with an emergency sending route database 133 (hereinafter, referred to as database 133). In the database 133, as shown in FIG. 10, the data, indicating the correspondence relations among the emergency call group numbers of the IP phone terminals T13, T22, and T33 that are the emergency notice destinations and the sending routes indicating the PSTN NW1, PSAP NW3 and ISDN NW, is stored.

On the other hand, when the emergency sending requests are sent from the IP phone terminals T11, T12, T21, T31, and T32 via the IP network IPN, the sending control unit 123 of the IP phone control unit 12 refers to the databases 131, 132, and 133 to execute sending processing to the IP phone terminals T13, T22, and T33 that are the emergency notice destinations by using the optimum sending route based on the reference results.

Next to this, operations of the IP phone system with the configuration given above will be described.

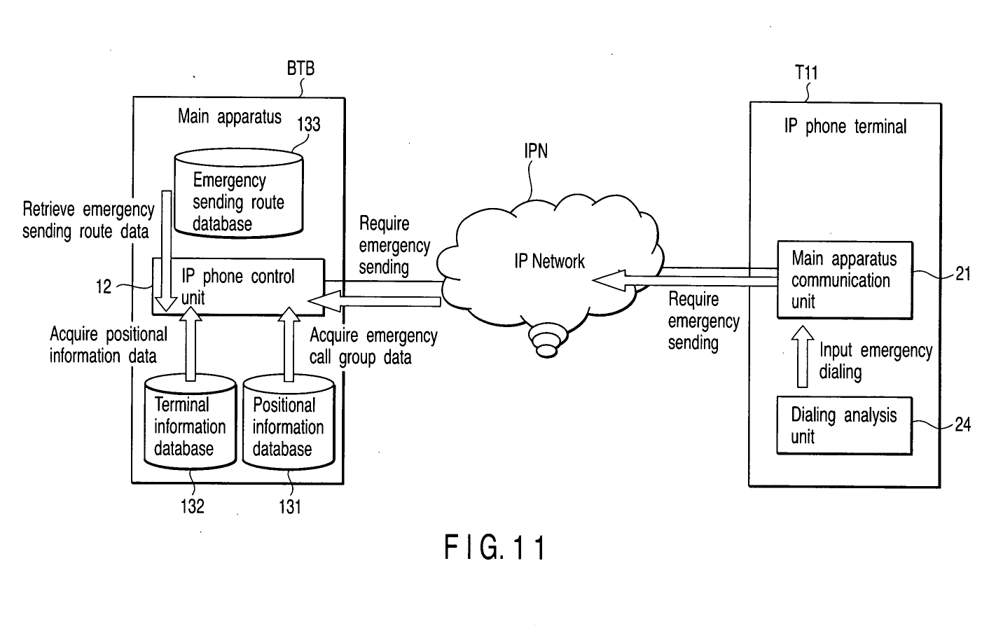

FIG. 11 is a sequence view illustrating the transmitting/receiving operations of the information between the main apparatus BTB and the IP phone terminal T11 in conducting the sending control for the emergency notice.

The IP phone terminal T11 performs a dial analysis by means of a dial analyzing unit 24, and when the analysis results in an emergency dial, the IP phone terminal T11 notifies an emergency dial input to the main apparatus communication unit 21, and transmits an emergency sending request from the main apparatus communication unit 21 to the main apparatus BTB.

In the main apparatus BTB, when the IP phone control unit 12 receives the emergency sending request, the control unit 12 acquires the positional information index updated at the time of the positional information registration, and further, acquires the emergency call group number from the database 131.

In the main apparatus BTB, the IP phone control unit 12 retrieves a sending route from the database 133 in accordance with the emergency call group number acquired by the IP phone control unit 12, and grasps the PSTN NW1 in accordance with the retrieval result to transmit an emergency dial.

Thus, the telephone system finally forms a communication link between the IP phone terminal T13 and the IP phone terminal T11 in the appropriate institutes and becomes possible to make a speech.

As mentioned above, in the second embodiment, the main apparatus BTB includes the data base 133 in which the emergency call group numbers and the sending routes indicating the PSTN NW1, PSAP NW2 and ISDN NW associated with one another. The main apparatus BTB specifies the connection routes in sending the emergency notice to the emergency notice destinations for each IP phone terminals T11, T12, T21, T31, and T32 to send the emergency notice to the emergency notice destinations through the specified connection routes.

Therefore, in the IP phone terminal T11 which frequently moves among each base, even if the emergency notice destination is present at any of the PSTN NW1, PSAP NW2, or ISDN NW3, the telephone system may send the emergency notice to an optimum emergency notice destination.

### Other Embodiment

The present invention is not limited to the each of the forgoing embodiments. For example, each embodiment having described about an example to use an IP phone terminal as a phone terminal, it is also acceptable, other than the example, for a terminal using a wireless LAN, and for a soft phone achieved by software on a personal computer to be used.

Other than this, as for the configuration and kind of the system, the configuration and kind of the main apparatus, the types of phone terminals, the storage contents of a variety of tables, selection control method of the emergency notice destination, or the like, various modifications may be embodied without departing from the sprit or scope of this invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A main apparatus of a communication system executing communication connections among a plurality of phone terminals connected to a packet communication network transferring communication packets, the plurality of phone terminals are assigned terminal IDs, comprising:
a first memory which stores a first management table in which an emergency ID specifying a first phone terminal to be an emergency notice destination among the plurality of phone terminals on the packet communication network and positional information indicating a connection position of the first phone terminal onto the packet communication network are associated with each other;
a second memory which stores a second management table in which a terminal of a second phone terminal differing from the first phone terminal and positional information indicating a connection position of the second phone terminal onto the packet communication network are associated with each other; and
a controller which refers to the first and the second management tables to execute a communication connection between the first and the second phone terminals based on the reference result when an emergency sending request including the terminal ID of the second phone terminal is transmitted from the second phone terminal via the packet communication network.

2. The main apparatus of the communication system according to claim 1, further comprising:
a transmitter which reads out the first management table from the first memory when the second phone terminal is activated and transmits an acquisition request for positional information including the first management table to the second phone terminal via the packet communication network; and
an updater which updates positional information of the corresponding second phone terminal in the second management table when the positional information of the second phone terminal is transmitted from the second phone terminal via the packet communication network in response to the transmission of the acquisition request of the positional information.

3. The main apparatus of the communication system according to claim 1, further comprising:
a third memory which stores a third management table in which the emergency call ID is associated with a network ID specifying the packet communication network and with a non-packet communication network when the first phone terminal is connected to the non-packet communication network differing from the packet communication network, wherein
the controller refers to the first, second, and third tables when the emergency sending request is transmitted from the second phone terminal, and specifies a connection route to the first phone terminal based on the reference results to execute a communication connection between the first and the second phone terminals, based on the connection route.

4. The main apparatus of the communication system according to claim 3, wherein the non-packet communication network is at least any one of an analog telephone network and an integrated service digital network.

5. An emergency notice sending method for use in a main apparatus of a communication system executing communication connections among a plurality of phone terminals connected to a packet communication network transferring communication packets and assigned terminal IDs, comprising:
storing a first management table, in which an emergency call ID specifying a first phone terminal to be an emergency notice destination among a plurality of phone terminals on the packet communication network and positional information indicating a connection position of the first phone terminal onto the packet communication network with each other, in a first memory;
storing a second management table, in which an terminal ID of a second phone terminal differing from the first phone terminal and positional information indicating a connection position of the second phone terminal onto the packet communication network with each other, in a second memory; and
referring to the first and the second management tables, comparing the positional information of the first phone terminal to the positional information of the second phone terminal, and executing a communication connection between the first and the second phone terminals, based on the comparison result when an emergency sending request including the terminal ID of the second phone terminal is transmitted from the second phone terminal via the packet communication network.
